(19) United States
(12) Patent Application Publication
(10) Pub. No.: US 2006/0040847 A1
(43) Pub. Date: Feb. 23, 2006

(54) Hard surface treating compositions

(76) Inventor: Albert Thomas Weibel, Montvale, NJ (US)

Correspondence Address: NORRIS, MCLAUGHLIN & MARCUS, 875 THIRD AVE, 18TH FLOOR, NEW YORK, NY, 10022, US

(21) Appl. No.: 10/527,074

(22) PCT Filed: Sep. 1, 2003
(86) PCT No.: PCT/GB03/03743

§ 371 Date: Apr. 22, 2005

(30) Foreign Application Priority Data
Sep. 10, 2002 (GB) 0220893.2

(51) Int. Cl. C11D 3/00

(52) U.S. Cl. 510/504

(57) ABSTRACT

A process for treating a surface comprising a first aqueous composition comprising hydrogen peroxide and a second aqueous composition comprising one or more cationic surfactants having germicidal properties, essential oils, other antimicrobial/germicidal agents, anionic surfactants, non-ionic surfactants or pH modifiers. The compositions can be applied simultaneously to a surface in need of sanitizing and/or disinfecting and/or cleaning and/or removing stains.

This invention relates to an improved process for sanitizing and/or disinfecting and/or cleaning and/or the removal of stains from hard and soft surfaces and to compositions used in such processes.

The use of oxygen bleaches in compositions for sanitizing and/or disinfecting and/or cleaning and/or for stain removal has been known for a long time and many such compositions are available. However a common difficulty in formulating such a composition is to ensure that it remains stable during storage but is sufficiently active on use. This is particularly difficult to achieve in liquid compositions containing peroxygen bleach. In addition it is extremely difficult to include other active substances, for example, cationic surfactants having germicidal properties, essential oils, or other antimicrobial/germicidal agents, into such systems. Such germicidal agents typically do not bleach stains. It is desirable in some instances to have a formulation which can effect both sanitization and bleaching without having to resort to products containing chlorine bleach, which can cause dye damage and harmful effects on surfaces. Many solutions have been proposed to this problem but most of these require the use of expensive stabilising components or of complex formulation processes.

The prior art suggests certain bleaching compositions, including those described in WO 00/12676; WO 98/33880; WO 01/00765; U.S. Pat. No. 2,525,312 and U.S. Pat. No. 4,687,663. However these compositions are not without shortcomings.

The present invention provides a composition of hydrogen peroxide with one or more cationic surfactants having germicidal properties, essential oils, other antimicrobial/germicidal agents, anionic surfactants, nonionic surfactants, or pH modifiers which has acceptable stability of both one or more catatonic surfactants having germicidal properties, essential oils, or antimicrobial/germicidal agents, anionic surfactants, nonionic surfactants, or pH modifiers and the peroxide after manufacture, but which is capable of providing effective sanitizing and/or disinfecting and/or cleaning and/or stain removal power to hard surfaces when used by the consumer. We have found that by separating the hydrogen peroxide from the one or more cationic surfactants having germicidal properties, essential oils, other antimicrobial/germicidal agents, anionic surfactants, nonionic surfactants, or pH modifiers, excellent stability is achieved. This is due to hydrogen peroxide being stable in acidic environments (pH <7) but active as a bleaching agent in alkaline environments (pH >7).

According to the invention there is provided a process for sanitizing and/or disinfecting and/or cleaning and/or stain removal at a surface, comprising applying to that surface a composition comprising a mixture of:
a) an aqueous composition comprising hydrogen peroxide [hereinafter component (a)] and
b) an aqueous composition [hereinafter component (b)] comprising one or more cationic surfactants having germicidal properties, essential oils, other antimicrobial/germicidal agents, anionic surfactants, nonionic surfactants, or pH modifiers,
   wherein components (a) and/or (b) optionally comprise at least one surfactant or water-soluble polymer and are mixed not more than two hours, preferably within minutes, and more preferably within seconds before being applied to the surface requiring sanitizing and/or disinfecting and/or cleaning and/or stain removal. The resulting composition that is applied to the surface in need of treatment will have a pH of greater than 7.00.

Compositions suitable for carrying out the invention may be provided as separate components suitable for mixing by the consumer. Where the compositions are suitable for mixing they may be mixed either directly at the surface or remote from the surface before application.

In accordance with the invention the two components (a) and (b) may be mixed in any suitable proportions, depending upon their initial concentrations, suitably such that the finally applied mixture comprises from about 0.01 to about 30% w/w of hydrogen peroxide. Preferably, the ratio of component (a) to component (b) is from 10:1 to 1:10, most preferably from 2:1 to 1:2.

It is preferred that the two components (a) and (b) are mixed no more than 10 minutes before application to the surface requiring sanitizing and/or disinfecting and/or cleaning and/or stain removal.

It is most preferred that the two components (a) and (b) are mixed at the surface requiring sanitizing and/or disinfecting and/or cleaning and/or stain removal, so that the improved sanitizing and/or disinfecting and/or cleaning and/or stain removal effect may occur immediately.

In this aspect component (a) may be applied to the surface followed by component (b) or vice versa. Alternatively (and preferably) components (a) and (b) are applied to the surface substantially simultaneously within 30 seconds.

According to a preferred embodiment of the presentation invention, the concentration of hydrogen peroxide in the composition immediately after mixing is from 0.01 to 10% w/w, preferably, from about 1.0 to about 5% w/w. This would mean for example in a 1:1 mix of component (a) and (b) that component (a) prior to the mixing would contain from 0.02 to 200/o w/w of hydrogen peroxide, preferably from about 2 to about 10% w/w.

The concentration of the cationic surfactants having germicidal properties, essential oils, or other antimicrobial/germicidal agents in component (b) will be between 0.01 and 10% wt.

The components suitable for use in the process according to the invention may further include any other conventional additives known to the art. Examples of these include fragrances, dyes, thickeners, pH buffers, sequesterants, chelating agents, preservatives, corrosion inhibitors or antioxidants.

The above auxiliary components may be included in the compositions suitable for use in the process of the present invention at concentrations of from about 0.01% w/w to about 10% w/w. These auxiliary ingredients may be included in either component (a), or component (b) or both if appropriate.

Compositions suitable for use in the process according to the present invention may be stored in any appropriate containers known to the art. For example, the two components may be stored in two-compartment packs suitable for sequential or simultaneous dispensing. Examples of two compartment dispensers include those disclosed in U.S. Pat. No. 3,760,986; U.S. Pat. No. 5,152,461; U.S. Pat. No. 5,332,157; U.S. Pat. No. 5,439,141; U.S. Pat. No. 5,560,545; U.S. Pat. No. 5,562,250; U.S. Pat. No. 5,626,259; U.S. Pat. No. 5,887,761; U.S. Pat. No. 5,964,377; U.S. Pat. No. 5,472,119; U.S. Pat. No. 5,385,270; U.S. Pat. No. 5,009,342; U.S. Pat. No. 4,902,281; U.S. Pat. No. 4,826,048; U.S. Pat. No. 5,339,990; U.S. Pat. No. 4,949,874, U.S. Pat. No. 5,562,250; U.S. Pat. No. 4,355,739; U.S. Pat. No. 3,786,963; U.S. Pat. No. 5,934,515; U.S. Pat. No. 3,729,553; U.S. Pat. No. 5,154,917; U.S. Pat. No. 5,289,950; U.S. Pat. No. 5,252,312; CA2306283; EP875460; EP979782; EP479451; and WO9505327.

Components (a) and (b) can stored in a two-compartment dispenser, one compartment containing each component and the dispenser being adapted to dispense each component on to a surface, either sequentially or, preferably, simultaneously.

According to a further aspect of the invention, there is provided a two-compartment dispenser comprising a first compartment containing an aqueous composition comprising hydrogen peroxide;
a second compartment containing an aqueous composition comprising one or more cationic surfactants having germicidal properties, essential oils, or antmicrobial/germicidal agents, anionic surfactants, nonionic surfactants, or pH modifiers, and;
dispensing means adapted to dispense the contents (or part thereof) of the compartments on to a surface either sequentially or simultaneously to form a mixture thereof.

Preferably wherein the first compartment and/or the second compartment additionally comprise at least one surfactant or water-soluble polymer.

Preferably, the first compartment contains an aqueous composition comprising from about 1 to about 50% w/w hydrogen peroxide; and the second compartment contains an aqueous composition comprising from about 0.01 to about 10% w/w of one or more cationic surfactants having germicidal properties, essential oils, or antimicrobial/germicidal agents, anionic surfactants, nonionic surfactants, or pH modifiers.

Component (a) is hydrogen peroxide. Optionally, anionic and/or nonionic surfactants can be mixed together with (a).

For component (b), examples of compositions which can be used as this component are set forth, for example, in U.S. Pat. No. 5,929,016; U.S. Pat. No. 6,090,771; U.S. Pat. No. 6,268,327; U.S. Pat. No. 6,143,710; U.S. Pat. No. 6,083,994; U.S. Pat. No. 6,022,841; U.S. Pat. No. 6,017,869; U.S. Pat. No. 6,358,900; U.S. Pat. No. 6,013,615; WO0123511; EP1146112; WO0226268; WO9953004; U.S. Pat. No. 5,403,587; U.S. Pat. No. 6,387,865; U.S. Pat. No. 6,387,866; U.S. Pat. No. 6,130,196; U.S. Pat. No. 6,384,010; U.S. Pat. No. 6,384,004; and U.S. Pat. No. 6,265,367, the contents of which are incorporated herein by reference. Therein, a variety of compositions useful in sanitizing and/or disinfecting and/or cleaning and/or stain removal from hard surfaces are presented using actives such as quaternary ammonium compounds, essential oils, and other antimicrobial/germicidal agents, usually together with nonionic surfactants, anionic surfactants (when cationic surfactants having germicidal properties or quaternary ammonium compounds are not used or other antimicrobial/germicidal agents which are incompatible with anionic surfactants are not used), non-aqueous solvents such as, for example, alcohols and/or glycol ethers, and optionally other solubilizers, colorants, fragrances, pH stabliziers, and the like.

Examples of quaternary ammonium compounds which can be used to make compositions of (b) include those described for example in McCutcheon's Detergents and Emulsifiers, North American Edition, 2001; Kirk-Othmer, Encyclopedia of Chemical Technology, 4th Ed., Vol. 23, pp. 478-541, the contents of which are herein incorporated by reference.

Examples of preferred cationic surfactant compositions useful in the practice of the instant invention are those which provide a germicidal effect to the concentrate compositions, and especially preferred are quaternary ammonium compounds and salts thereof, which may be characterized by the general structural formula: 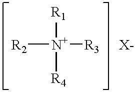
where at least one of R₁, R₂, R₃ and R₄ is a alkyl, aryl or alkylaryl substituent of from 6 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl, arylalkyl, etc. The remaining substituents on the nitrogen atoms other than the abovementioned alkyl substituents are hydrocarbons usually containing no more than 12 carbon atoms. The substituents R₁, R₂, R₃ and R₄ may be straight-chained or may be branched, but are preferably straight-chained, and may include one or more amide, ether or ester linkages. The counterion X may be any salt-forming anion which permits water solubility of the quaternary ammonium complex.

Exemplary quaternary ammonium salts within the above description include the alkyl ammonium halides such as cetyl trimethyl ammonium bromide, alkyl aryl ammonium halides such as octadecyl dimethyl benzyl ammonium bromide, N-alkyl pyridinium halides such as N-cetyl pyridinium bromide, and the like. Other suitable types of quaternary ammonium salts include those in which the molecule contains either amide, ether or ester linkages such as octyl phenoxy ethoxy ethyl dimethyl benzyl ammonium chloride, N-(laurylcocoaminoformylmethyl)-pyridinium chloride, and the like. Other very effective types of quaternary ammonium compounds which are useful as germicides include those in which the hydrophobic radical is characterized by a substituted aromatic nucleus as in the case of lauryloxyphenyltrimethyl ammonium chloride, cetylaminophenyltrimethyl ammonium methosulfate, dodecylphenyltrimethyl ammonium methosulfate, dodecylbenzyltrimethyl ammonium chloride, chlorinated dodecylbenzyltrimethyl ammonium chloride, and the like.

Preferred quaternary ammonium compounds which act as germicides and which are found to be useful in the practice of the present invention include those which have the structural formula: 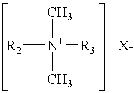
wherein R₂ and R₃ are the same or different C₈-C₁₂alkyl, or R₂ is C₁₂₋₁₆alkyl, C₈₋₁₆alkylethoxy, C₈₋₁₈alkylphenoxyethoxy and R₃ is benzyl, and X is a halide, for example chloride, bromide or iodide, or is a methosulfate anion. The alkyl groups recited in R₂ and R₃ may be straight-chained or branched, but are preferably substantially linear.

Particularly useful quaternary germicides include compositions which include a single quaternary compound, as well as mixtures of two or more different quaternary compounds.

Such useful quaternary compounds are available under the BARDAC®, BARQUAT®, HYAMINE®, LONZABAC®, BTC®, and ONYXIDE® trademarks, which are more fully described in, for example, McCutcheon's Functional Materials (Vol. 2), North American Edition, 2001, and the respective product literature from the suppliers identified below. For example, BARDAC® 205M is described to be a liquid containing alkyl dimethyl benzyl ammonium chloride, octyl decyl dimethyl ammonium chloride; didecyl dimethyl ammonium chloride, and dioctyl dimethyl ammonium chloride (50% active) (also available as 80% active (BARDAC® 208M)); described generally in McCutcheon's as a combination of alkyl dimethyl benzyl ammonium chloride and dialkyl dimethyl ammonium chloride); BARDAC® 2050 is described to be a combination of octyl decyl dimethyl ammonium chloride/didecyl dimethyl ammonium chloride, and dioctyl dimethyl ammonium chloride (50% active) (also available as 80% active (BARDAC® 2080)); BARDAC® 2250 is described to be didecyl dimethyl ammonium chloride (50% active); BARDAC® LF (or BARDAC® LF-80), described as being based on dioctyl dimethyl ammonium chloride (BARQUAT® MB-50, MX-50, OJ-50 (each 50% liquid) and MB-80 or MX-80 (each 80% liquid) are each described as an alkyl dimethyl benzyl ammonium chloride; BARDAC® 4250 and BARQUAT® 4250Z (each 50% active) or BARQUAT® 4280 and BARQUAT® 4280Z (each 80% active) are each described as alkyl dimethyl benzyl ammonium chloride/alkyl dimethyl ethyl benzyl ammonium chloride. Also, HYAMINE® 1622, described as diisobutyl phenoxy ethoxy ethyl dimethyl benzyl ammonium chloride (available either as 100% actives or as a 50% actives solution); HYAMINE® 3500 (50% actives), described as alkyl dimethyl benzyl ammonium chloride (also available as 80% active (HYAMINE®D 3500-80); and HYAMINE® 2389 described as being based on methyldodecylbenzyl ammonium chloride and/or methyldodecylxylene-bis-trimethyl ammonium chloride. (BARDAC®, BARQUAT® and HYAMINE® are presently commercially available from Lonza, Inc., Fairlawn, N.J.). BTC® 50 NF (or BTC® 65 NF) is described to be alkyl dimethyl benzyl ammonium chloride (50% active); BTC® 99 is described as didecyl dimethyl ammonium chloride (50% active); BTC® 776 is described to be myristalkonium chloride (50% active); BTC® 818 is described as being octyl decyl dimethyl ammonium chloride, didecyl dimethyl ammonium chloride, and dioctyl dimethyl ammonium chloride (50% active) (available also as 80% active (BTC® 818-80%)); BTC® 824 and BTC® 835 are each described as being of alkyl dimethyl benzyl ammonium chloride (each 50% active); BTC® 885 is described as a combination of BTC® 835 and BTC® 818 (50% active) (available also as 80% active (BTC® 888)); BTC® 1010 is described as didecyl dimethyl ammonium chloride (50% active) (also available as 80% active (BTC® 1010-80)); BTC® 2125 (or BTC® 2125 M) is described as alkyl dimethyl benzyl ammonium chloride and alkyl dimethyl ethylbenzyl ammonium chloride (each 50% active) (also available as 80% active (BTC® 2125-80 or BTC® 2125 M)); BTC® 2565 is described as alkyl dimethyl benzyl ammonium chlorides (50% active) (also available as 80% active (BTC® 2568)); BTC® 8248 (or BTC® 8358) is described as alkyl dimethyl benzyl ammonium chloride (80% active) (also available as 90% active (BTC® 8249)); ONYXIDE® 3300 is described as n-alkyl dimethyl benzyl ammonium saccharinate (95% active). (BTC® and ONYXIDE® are presently commercially available from Stepan Company, Northfield, Ill.).

Examples of essential oils that can be used to make compositions of (b) include oils of anise, citrus, aniseed, roses, mint, camphor, lemon, orange, rosemary, wintergreen, thyme, lavender, cloves, hops, tea tree, citronella, wheat, barley, lemongrass, cedar leaf, cedarwood, cinnamon, fleagrass, geranium, sandalwood, violet, cranberry, eucalyptus, vervain, peppermint, gum benzoin, basil, fennel, fir, balsam, menthol, ocmea origanum, hydastis carradensis, berberidaceae daceae, ratanhiae and curcuma longa. Also included in this class of natural essential oils are the key chemical components of the plant oils which have been found to provide the antimicrobial benefit. These chemicals include, but are not limited to anethol, catechole, camphene, pinocarvone, cedrol, thymol, eugenol, eucalyptol, ferulic acid, famesol, hinokitiol, tropolone, limonene, menthol, methyl salicylate, carvacol, terpineol, verbenone, berberine, ratanhiae extract, caryophellene oxide, citronellic acid, curcumin, nerolidol and geraniol.

Examples of other antimicrobial/germicidal agents which may be present in minor amounts in the inventive compositions of the present application include, in addition to the germicidal cationic surfactants mentioned above, pyrithiones especially the zinc complex (Zpt), Octopirox®, dimethyldimethylol hydantoin (Glydant®) methylchloroisothiazolinone/methylisothiazolinone (Kathon CG®), benzoic acid, benzoyl peroxide, salicylamides, picric acid, xylenol, pyrocatechol, pyrogallol, phloroglucin, imidazolidinyl urea (Germall 115®), diazolidinyl urea (Germaill II®), benzyl alcohol, 2-bromo-2-nitropropane-1,3-diol (Bronopol®), formalin (formaldehyde), iodopropenyl butylcarbamate (Polyphase P100®), chloroacetamide, methanamine, methyldibromonitrile glutaronitrile (1,2-dibromo-2,4-dicyanobutane or Tektamer®), glutaraldehyde, 5-bromo-5-nitro-1,3-dioxane (Bronidox®), phenethyl alcohol, o-phenylphenol/sodium o-phenylphenol, sodium hydroxymethylglycinate (Suttocide A®), polymethoxy bicyclic oxazolidine (Nuosept C®), dimethoxane, thimersal, dichlorobenzyl alcohol, captan, chlorphenenesin, hexachlorophene, tetrachlorophene, 3,3′-dibromo-5,5′-dichloro-2,2′-dihydroxydiphenylamine, dichlorophene, chlorbutanol, glyceryl laurate, halogenated diphenyl ethers, 2,4,4′-trichloro-2′-hydroxy-diphenyl ether (Triclosan® or TCS), 2,2′-dihydroxy-5,5′-dibromo-diphenyl ether, phenolic compounds, phenol, 2-methyl phenol, 3-methyl phenol, 4-methyl phenol, 4-ethyl phenol, 2,4-dichlorophenol, p-nitrophenol, 2,4-dimethyl phenol, 2,5-dimethyl phenol, 3,4-dimethyl phenol, 2,6-dimethyl phenol, 4-n-propyl phenol, 4-n-butyl phenol, 4-n-amyl phenol, 4-tert-amyl phenol, 4-n-hexyl phenol, 4-n-heptyl phenol, mono- and poly-alkyl and aromatic halophenols, p-chlorophenol, methyl p-chlorophenol, ethyl p-chlorophenol, n-propyl p-chlorophenol, n-butyl p-chlorophenol, n-amyl p-chlorophenol, sec-amyl p-chlorophenol, n-hexyl p-chlorophenol, cyclohexyl p-chlorophenol, n-heptyl p-chlorophenol, n-octyl p-chlorophenol, o-chlorophenol, methyl o-chlorophenol, ethyl o-chlorophenol, n-propyl o-chlorophenol, n-butyl o-chlorophenol, n-amyl o-chlorophenol, tert-amyl o-chlorophenol, n-hexyl o-chlorophenol, n-heptyl o-chlorophenol, o-benzyl p-chlorophenol, o-benzyl-m-methyl p-chlorophenol, o-benzyl-m, m-dimethyl p-chlorophenol, o-phenylethyl p-chlorophenol, o-phenylethyl-m-methyl p-chlorophenol, 3-methyl p-chlorophenol, 3,5-dimethyl p-chlorophenol, 6-ethyl-3-methyl p-chlorophenol, 6-n-propyl-3-methyl p-chlorophenol, 6-iso-propyl-3-methyl p-chlorophenol, 2-ethyl-3,5-dimethyl p-chlorophenol, 6-sec-butyl-3-methyl p-chlorophenol, 2-iso-propyl-3,5-dimethyl p-chlorophenol, 6-diethylmethyl-3-methyl p-chlorophenol, 6-iso-propyl-2-ethyl-3-methyl p-chlorophenol, 2-sec-amyl-3,5-dimethyl p-chlorophenol, 2-diethylmethyl-3,5-dimethyl p-chlorophenol, 6-sec-octyl-3-methyl p-chlorophenol, o-benzylphenol, p-chloro-o-benzylphenol, cresols (o-, m-, p-), p-chloro-m-cresol, p-bromophenol, methyl p-bromophenol, ethyl p-bromophenol, n-propyl p-bromophenol, n-butyl p-bromophenol, n-amyl p-bromophenol, sec-amyl p-bromophenol, n-hexyl p-bromophenol, cyclohexyl p-bromophenol, o-bromophenol, tert-amyl o-bromophenol, n-hexyl o-bromophenol, n-propyl-m,m-dimethyl o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5,6-terabromo-2-methylphenol, 5-methyl-2-pentylphenol, 4-isopropyl-3-methylphenol, para-chloro-meta-xylenol, chlorothymol, phenoxyethanol, phenoxyisopropanol, 5-chloro-2-hydroxydiphenylmethane, resorcinol and its derivatives, resorcinol, methyl resorcinol, ethyl resorcinol, n-propyl resorcinol, n-butyl resorcinol, n-amyl resorcinol, n-hexyl resorcinol, n-heptyl resorcinol, n-octyl resorcinol, n-nonyl resorcinol, phenyl resorcinol, benzyl resorcinol, phenylethyl resorcinol, phenylpropyl resorcinol, p-chlorobenzyl resorcinol, 5-chloro 2,4-dihydroxydiphenyl methane, 4′-chloro 2,4-dihydroxydiphenyl methane, 5-bromo 2,4-dihydroxydiphenyl methane, 4′-bromo 2,4-dihydroxydiphenyl methane, bisphenolic compounds, 2,2′-methylene bis(4-chlorophenol), 2,2′-methylene bis(3,4,6-trichlorophenol), 2,2′-methylene bis(4-chloro-6-bromophenol), bis(2-hydroxy-3,5-dichlorophenyl) sulphide, bis(2-hydroxy-5-chlorobenzyl)sulphide, benzoic esters parabens such as methylparaben, propylparaben, butylparaben, ethylparaben, isopropylparaben, isobutylparaben, benzylparaben, sodium methylparaben, sodium propylparaben, halogenated carbanilides, 3,4,4′-trichlorocarbanilides (Trichlocarban® or TCC), 3-trifluoromethyl-4,4′-dichlorocarbanilide, and 3,3′,4-trichlorocarbanilide.

The cationic surfactants having germicidal properties, essential oils, or other antmicrobial/germicidal agents can be combined with, for example, one or more nonionic surfactants, non-aqueous solvents such as, for example, alcohols and/or glycol ethers, alkanolamines and the like to form compositions useful as (b) for the present invention. Examples of nonionic surfactants, alcohols and/or glycol ethers which are suitable for use are described below.

Nonlimiting examples of suitable nonionic surfactants which may be used in the present invention include:

(1) The polyethylene oxide condensates of alkyl phenols. These compounds include the condensation products of alkyl phenols having an alkyl group containing from about 6 to 12 carbon atoms in either a straight chain or branched chain configuration with ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like. Examples of compounds of this type include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

(2) The condensation products of aliphatic alcohols with from about 1 to about 60 moles of ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). One example of such a nonionic surfactant is available as Empilan KM 50.

(3) Alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

Other nonionic surfactants containing the characteristic alkylene oxide blocks are those which may be generally represented by the formula (A):
HO-(EO)ₓ(PO)_{y}(EO)_{z}-H (A)
where
EO represents ethylene oxide,
PO represents propylene oxide,
y equals at least 15,

(EO)_{x+y} equals 20 to 50% of the total weight of said compounds, and, the total molecular weight is preferably in the range of about 2000 to 15,000. These surfactants are available under the PLURONIC tradename from BASF or Emulgen from Kao.

Another group of nonionic surfactants can be represented by the formula (B):
R-(EO,PO)ₐ(EO,PO)_{b}-H (B)
wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further nonionic surfactants containing polymeric butoxy (BO) groups can be represented by formula (C) as follows:
RO-(BO)ₙ(EO)ₓ-H (C)
wherein
R is an alkyl group containing l to 20 carbon atoms,
n is about 5-15 and x is about 5-15.

Also further nonionic block copolymer surfactants, which also include polymeric butoxy groups, are those which may be represented by the following formula (D):
HO-(EO)ₓ(BO)ₙ(EO)_{y}-H (D)
wherein
n is about 5-15, preferably about 15,
x is about 5-15, preferably about 15, and
y is about 5-15, preferably about 15.

Still further nonionic block copolymer surfactants include ethoxylated derivatives of propoxylated ethylene diamine, which may be represented by the following formula: 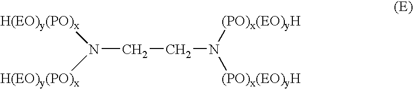
where
(EO) represents ethoxy,
(PO) represents propoxy,
   the amount of (PO)ₓ is such as to provide a molecular weight prior to ethoxylation of about 300 to 7500, and the amount of (EO)_{y} is such as to provide about 20% to 90% of the total weight of said compound.

Other examples of non-ionic surfactants include linear alcohol ethoxylates. The linear alcohol ethoxylates which may be employed in the present invention are generally include the C₆-C₁₅ straight chain alcohols which are ethoxylated with about 1 to 13 moles of ethylene oxide.

Examples include Alfonic® 810-4.5, which is described in product literature from Sasol North America Inc. as having an average molecular weight of 356, an ethylene oxide content of about 4.85 moles (about 60 wt. %), and an HLB of about 12; Alfonic® 810-2, which is described in product literature from Sasol North America Inc. as having an average molecular weight of 242, an ethylene oxide content of about 2.1 moles (about 40 wt. %), and an HLB of about 12; and Alfonic® 610-3.5, which is described in product literature from Sasol North America Inc. as having an average molecular weight of 276, an ethylene oxide content of about 3.1 moles (about 50 wt. %); and an HLB of 10. Product literature from Sasol North America Inc. also identifies that the numbers in the alcohol ethoxylate name designate the carbon chain length (numbers before the hyphen) and the average moles of ethylene oxide (numbers after the hyphen) in the product. These examples are typically C₆-C₁₁ straight-chain alcohols which are ethoxylated with from about 3 to about 6 moles of ethylene oxide.

Other examples of ethoxylated alcohols include the Neodol® 91 series non-ionic surfactants available from Shell Chemical Company which are described as C₉-C₁₁ ethoxylated alcohols. The Neodol® 91 series non-ionic surfactants of interest include Neodol 91-2.5, Neodol 91-6, and Neodol 91-8. Neodol 91-2.5 has been described as having about 2.5 ethoxy groups per molecule; Neodol 91-6 has been described as having about 6 ethoxy groups per molecule; and Neodol 91-8 has been described as having about 8 ethoxy groups per molecule. Another example includes a C₁₁ linear primary alcohol ethoxylate averaging about 9 moles of ethylene oxide per mole of alcohol, available, for example, under the commercial name of Neodol 1-9.

Further examples of ethoxylated alcohols include the Rhodasurf® DA series non-ionic surfactants available from Rhodia which are described to be branched isodecyl alcohol ethoxylates. Rhodasurf DA-530 has been described as having 4 moles of ethoxylabon and an HLB of 10.5; Rhodasurf DA-630 has been described as having 6 moles of ethoxylation with an HLB of 12.5; and Rhodasurf DA-639 is a 90% solution of DA-630.

Further examples of ethoxylated alcohols include those from Tomah Products (Milton, Wis.) under the Tomadol tradename with the formula RO(CH₂CH₂O)ₙH where R is the primary linear alcohol and n is the total number of moles of ethylene oxide. The ethoxylated alcohol series from Tomah include 91-2.5; 91-6; 91-8—where R is linear C9/C10/C11 and n is 2.5, 6, or 8; 1-3; 1-5; 1-7; 1-73B; 1-9; —where R is linear C11 and n is 3, 5, 7 or 9; 23-1; 23-3; 23-5; 23-6.5—where R is linear C12/C13 and n is 1, 3, 5, or 6.5; 25-3; 25-7; 25-9; 25-12—where R is linear C12/C13 C14/C15 and n is 3, 7, 9, or 12; and 45-7; 45-13—where R is linear C14/C15 and n is 7 or 13.

Other examples of nonionic surfactants include primary and secondary linear and branched alcohol ethoxylates, such as those based on C₆-C₁₈ alcohols which further include an average of from 2 to 80 moles of ethoxylation per mol of alcohol. These examples include the Genapol UD series from Clariant, described as tradenames Genapol UD 030, C₁₁-Oxo-alcohol polyglycol ether with 3 EO; Genapol UD, 050 C₁₁-Oxo-alcohol polyglycol ether with 5 EO; Genapol UD 070, C₁₁-Oxo-alcohol polyglycol ether with 7 EO; Genapol UD 080, C₁₁-Oxo-alcohol polyglycol ether with 8 EO; Genapol UD 088, C₁₁-Oxo-alcohol polyglycol ether with 8 EO; and Genapol UD 110, C₁₁-Oxo-alcohol polyglycol ether with 11 EO.

Other examples include those surfactants having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Surfactants of this formula are presently marketed under the Genapol® tradename, available from Clariant, Charlotte, N.C., include the 26-L series of the general formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1,26-L-1.6, 26-L-2,26-L-3,26-L-5,26-L45, 26-L-50, 26-L-60, 26-L-60N, 26-L-75, 26-L-80, 26-L-98N, and the 24-L series, derived from synthetic sources and typically contain about 55% C₁₂ and 45% C₁₄ alcohols, such as 24-L-3, 24L-45, 24-L-50, 24-L-60, 24-L-60N, 24L-75, 24-L-92, and 24-L-98N. From product literature, the single number following the “L” corresponds to the average degree of ethoxylation (numbers between 1 and 5) and the two digit number following the letter “L” corresponds to the cloud point in ° C. of a 1.0 wt. % solution in water.

Other examples of alcohol ethoxylates are C₁₀oxo-alcohol ethoxylates available from BASF under the Lutensol ON tradename. They are available in grades containing from about 3 to about 11 moles of ethylene oxide (available under the names Lutensol ON 30; Lutensol ON 50; Lutensol ON 60; Lutensol ON 65; Lutensol ON 66; Lutensol ON 70; Lutensol ON 80; and Lutensol ON 110).

Another class of nonionic surfactants include amine oxide compounds which may be defined as one or more of the following of the four general classes:
(1) Alkyl di (lower alkyl) amine oxides in which the alkyl group has about 6-24, and preferably 8-18 carbon atoms, and can be straight or branched chain, saturated or unsaturated. The lower alkyl groups include between 1 and 7 carbon atoms, but preferably each include 1-3 carbon atoms. Examples include octyl dimethyl amine oxide, lauryl dimethyl amine oxide, myristyl dimethyl amine oxide, and those in which the alkyl group is a mixture of different amine oxides, such as dimethyl cocoamine oxide, dimethyl (hydrogenated tallow) amine oxide, and myristyvpaimityl dimethyl amine oxide;
(2) Alkyl di (hydroxy lower alkyl) amine oxides in which the alkyl group has about 6-22, and preferably 8-18 carbon atoms, and can be straight or branched chain, saturated or unsaturated. Examples include bis-(2-hydroxyethyl) cocoamine oxide, bis-(2-hydroxyethyl) tallowamine oxide; and bis-(2-hydroxyethyl) stearylamine oxide;
(3) Alkylamidopropyl di(lower alkyl) amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and
(4) Alkylmorpholine oxides in which the alkyl group has about 1020, and preferably 12-16 carbon atoms, and can be straight or branched chain, saturated or unsaturated.

While these amine oxides recited above may be used, preferred are amine oxides which may be represented by the following structural representation: 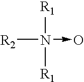
wherein
each R₁ independently is a straight chained C₁-C₄alkyl group; and,
R₂ is a straight chained C₆-C₂₂ alkyl group or an alkylamidoalkylene having the
formula 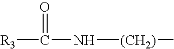
where R₃ is C₅-C₂₀ alkyl or
   —(CH₂)ₚ—OH
where n is 1 to 5 and p is 1 to 6; additionally, R2 or R3 could be ethoxylated (1 to 10 moles EO/mol) or propoxylated (1 to 10 moles of PO/mol).

Each of the alkyl groups may be linear or branched, but most preferably are linear. Examples include Ammonyx® LO which is described to be as a 30% wt. active solution of lauryl dimethyl amine oxide; Ammonyx® CDO Special, described to be a about 30% wt. active solution of cocoamidopropylamine oxide, as well as Ammonyx® MO, described to be a 30% wt. active solution of myristyldimethylamine oxide, all available from Stepan Company (Northfield, Ill.) with similar materials also available from Lonza under the Barlox trademark.

Examples of non-aqueous solvents which can be used in minor amounts in the inventive compositions include those which are at least partially water-miscible such as alcohols, (e.g., low molecular weight alcohols, such as, for example, ethanol, propanol, isopropanol, and the like), glycols (such as, for example, ethylene glycol, propylene glycol, hexylene glycol, and the like), water-miscible ethers (e.g. diethylene glycol diethylether, diethylene glycol dimethylether, propylene glycol dimethylether), water-miscible glycol ether (e.g. propylene glycol monomethylether, propylene glycol mono ethylether, propylene glycol monopropylether, propylene glycol monobutylether, propylene glycol monohexyl ether, ethylene glycol monobutylether, dipropylene glycol monomethylether, dipropylene glycol monobutylether, diethyleneglycol monobutylether), lower esters of monoalkylethers of ethyleneglycol or propylene glycol (e.g. propylene glycol monomethyl ether acetate) all commercially available such as from Union Carbide (Danbury, Conn.), Dow Chemical Co. (Midland, Mich.) or Hoechst (Germany). Mixtures of several organic solvents can also be used.

Preferred non-aqueous solvents which can be used in minor amounts in the inventive compositions are glycol ethers. Exemplary useful glycol ethers are those having the general structure Ra-O-Rb-Oh, Wherein Ra is an Alkyl of 1 to 20 Carbon atoms, or an aryl of at least 6 carbon atoms, and Rb is an alkylene of 1 to 8 carbons or is an ether or polyether containing from 2 to 20 carbon atoms. Exemplary glycol ethers include propylene glycol methyl ether, dipropylene glycol methyl ether, tripropylene glycol methyl ether, propylene glycol isobutyl ether, ethylene glycol methyl ether, ethylene glycol ethyl ether, ethylene glycol butyl ether, diethylene glycol phenyl ether, propylene glycol phenol ether, dipropylene glycol monobutyl ether and mixtures thereof. Specific examples of more preferred glycol ether solvents include propylene glycol methyl ether, dipropylene glycol methyl ether, tripropylene glycol methyl ether, propylene glycol isobutyl ether, ethylene glycol methyl ether, ethylene glycol ethyl ether, ethylene glycol butyl ether, diethylene glycol phenyl ether, propylene glycol phenol ether, and mixtures thereof.

When quaternary ammonium compounds, cationic surfactants having germicidal properties are not used or other antimicrobial/germicidal agents which are incompatible with anionic surfactants are not used, anionic surfactants can be added as a component of (b) and/or be present as an additional component of (a). Examples of anionic surfactants include, for example, alkali metal salts, ammonium salts, amine salts, or aminoalcohol salts of one or more of the following compounds (linear and secondary): alcohol sulfates and sulfonates, alcohol phosphates and phosphonates, alkyl sulfates, alkyl ether sulfates, sulfate esters of an alkylphenoxy polyoxyethylene ethanol, alkyl monoglyceride sulfates, alkyl sulfonates, olefin sulfonates, paraffin sulfonates, beta-alkoxy alkane sulfonates, alkylamidoether sulfates, alkylaryl polyether sulfates, monoglyceride sulfates, alkyl ether sulfonates, ethoxylated alkyl sulfonates, alkylaryl sulfonates, alkyl benzene sulfonates, alkylamide sulfonates, alkyl monoglyceride sulfonates, alkyl carboxylates, alkyl sulfoacetates, alkyl ether carboxylates, alkyl alkoxy carboxylates having 1 to 5 moles of ethylene oxide, alkyl sulfosuccinates, alkyl ether sulfosuccinates, alkylamide sulfosuccinates, alkyl sulfosuccinamates, octoxynol or nonoxynol phosphates, alkyl phosphates, alkyl ether phosphates, taurates, N-acyl taurates, fatty taurides, fatty acid amide polyoxyethylene sulfates, isethionates, acyl isethionates, and sarcosinates, acyl sarcosinates, or mixtures thereof. Generally, the alkyl or acyl radical in these various compounds comprise a carbon chain containing 12 to 20 carbon atoms.

Examples of pH modifiers suitable for hydrogen peroxide systems include, but are not limited to, alkali and alkaline earth carbonates, hydroxides, bicarbonates, borates, and phosphates as well as alkanolamines, examples of which include monoethanolamine, isopropanolamine, and the like.

Examples of (a) and (b) are shown below.

| | | |
|---|---|---|
| (a) | Hydrogen peroxide | 3.00 wt % |
| | Genapol 26-L-60 | 0.20 wt % |

| (b) | | | | | | |
|---|---|---|---|---|---|---|
| Constituent | (b)1 | (b)2 | (b)3 | (b)4 | (b)5 | (b)6 |
| n-alkyl (67% C₁₂; 25% C₁₄; 7% C₁₆; 1% C₈, C₁₀, C₁₈) | 0.20 | 0.20 | 0.20 | 0.20 | 0.20 | 0.20 |
| dimethyl benzyl ammonium chloride | | | | | | |
| Propylene glycol mono-n-butyl ether | 8.00 | | 4.00 | | 8.00 | 2.00 |
| Dipropylene glycol mono-n-butyl ether | | 6.00 | | 6.00 | | |
| n-decanol | | | | 0.07 | | |
| Lauryl dimethyl amine oxide | 1.62 | 0.88 | 0.70 | 0.88 | 0.70 | 0.20 |
| Monoethanolamine | 1.00 | 1.00 | 1.00 | 1.00 | 1.00 | 0.20 |
| Conventional additives | 0.30 | | | | | 0.04 |
| Water | q.s. | q.s. | q.s. | q.s. | q.s. | q.s. |
| Constituent | (b)7 | (b)8 | (b)9 | b(10) | b(11) | b(12) |
| n-alkyl (67% C₁₂; 25% C₁₄; 7% C₁₆; 1% C₈, C₁₀, C₁₈) | 0.20 | 0.20 | 0.344 | 0.344 | 0.344 | 0.344 |
| dimethyl benzyl ammonium chloride | | | | | | |
| n-alkyl (50% C₁₄; 40% C₁₂; | | | 0.054 | 0.054 | 0.054 | 0.054 |
| 10% C₁₆) dimethyl benzyl | | | | | | |
| quaternary ammonium chloride | | | | | | |
| Dipropylene glycol mono-n-butyl ether | 6.00 | | 4.00 | 4.00 | 2.00 | 1.00 |
| Diethylene glycol mono-n-butyl ether | | 12.00 | | | | |
| n-decanol | 0.08 | 0.20 | | 0.08 | 0.08 | 0.08 |
| Lauryl dimethyl amine oxide | 1.80 | 1.80 | 4.00 | 6.00 | 6.00 | 6.00 |
| Monoethanolamine | 1.00 | 1.00 | 1.50 | 1.50 | 1.50 | 1.50 |
| Conventional additives | 0.40 | 0.40 | 0.70 | 0.40 | 0.40 | 0.40 |
| Water | q.s. | q.s. | q.s. | q.s. | q.s. | q.s. |
| Constituent: | b(13) | b(14) | b(15) | b(16) | b(17) | b(18) |
| n-alkyl (67% C₁₂; 25% C₁₄; 7% C₁₆; 1% C₈, C₁₀, C₁₈) | 0.344 | 0.344 | 0.344 | 0.344 | 0.344 | 0.344 |
| dimethyl benzyl ammonium chloride | | | | | | |
| n-alkyl (50% C₁₄; 40% C₁₂; 10% C₁₆) dimethyl | 0.054 | 0.054 | 0.054 | 0.054 | 0.054 | 0.054 |
| benzyl quaternary ammonium chloride | | | | | | |
| Dipropylene glycol mono-n-butyl ether | 2.00 | 4.00 | 2.00 | 2.00 | 2.00 | 2.00 |
| n-decanol | 0.04 | 0.08 | 0.08 | 0.08 | 0.04 | 0.04 |
| Lauryl dimethyl amine oxide | 4.00 | 6.00 | 6.00 | 4.00 | 6.00 | 4.00 |
| Monoethanolamine | 1.50 | 2.00 | 2.00 | 1.50 | 1.50 | 1.50 |
| Conventional additives | 0.40 | 0.40 | 0.40 | 0.40 | 0.40 | 0.40 |
| Water | q.s. | q.s. | q.s. | q.s. | q.s. | q.s. |

Examples of hard surfaces to which the invention can be applied include surfaces composed of refractory materials such as: glazed and unglazed tile, porcelain, ceramics as well as stone including marble, granite, and other stones surfaces; glass; metals; plastics e.g. polyester, vinyl; Fiberglas, Formica®, Corian® and other hard surfaces known to the industry. Hard surfaces which are to be particularly denoted are lavatory fixtures such as shower stalls, bathtubs and bathing appliances (racks, shower doors, shower bars) toilets, bidets, wall and flooring surfaces especially those which include refractory materials and the like. Further hard surfaces which are to be denoted include painted surfaces and those associated with kitchen environments and other environments associated with food preparation, including cabinets and countertop surfaces as well as walls and floor surfaces especially those which include refractory materials, plastics, Formica®, Corian® and stone.

Examples of soft surfaces include fabrics, textiles, carpets, rugs, draperies and the like made from natural and man-made fibers.

1. A process for sanitizing and/or disinfecting and/or cleaning and/or stain removal at a surface, comprising applying to that surface a mixture having a pH of greater than 7.00 of:
(a) an aqueous composition comprising hydrogen peroxide; and
(b) an aqueous composition necessarily comprising one or more cationic surfactants having germicidal properties, as well as further optionally comprising one or more essential oils, other antimicrobial/germicidal agents, anionic surfactants, non-ionic surfactants, and pH modifiers, wherein components (a) or (b) optionally comprise at least one surfactant and are mixed not more than two hours before being applied to the surface requiring sanitizing and/or disinfecting and/or cleaning and/or stain removal.

2. The process of claim 1 wherein after both components (a) and (b) are applied to the surface, the pH of the resulting solution is greater than 7.00.

3. The process according to claim 1 wherein the one or more cationic surfactants having germicidal properties are characterized by the formula: 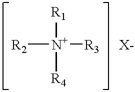
wherein at least one of R₁, R₂, R₃ and R₄ is a alkyl, aryl or alkylaryl substituent of from 6 to 26 carbon atoms, the remaining R₁, R₂, R₃ and R₄ are hydrocarbons usually containing no more than 12 carbon atoms, and X is any salt-forming anion.

4. The process according to claim 1 wherein component (b) includes essential oils.

5. The process according to claim 4 wherein component (b) is selected from oils of anise, citrus, aniseed, roses, mint, camphor, lemon, orange, rosemary, wintergreen, thyme, lavender, cloves, hops, tea tree, citronella, wheat, barley, lemongrass, cedar leaf, cedarwood, cinnamon, fleagrass, geranium, sandalwood, violet, cranberry, eucalyptus, vervain, peppermint, gum benzoin, basil, fennel, fir, balsam, menthol, ocmea origanum, hydastis carradensis, berberidaceae daceae, ratanhiae, curcuma longa, anethol, catechole, camphene, pinocarvone, cedrol, thymol, eugenol, eucalyptol, ferulic acid, farnesol, hinokitiol, tropolone, limonene, menthol, methyl salicylate, carvacol, terpineol, verbenone, berberine, ratanhiae extract, caryophellene oxide, citronellic acid, curcumin, nerolidol and geraniol and mixtures thereof.

6. The process according to claim 1 wherein component (b) comprises further antimicrobial/germicidal agents.

7. The process according to claim 6 wherein the other antimicrobial/germicidal agents of (b) is selected from pyrithiones especially the zinc complex, dimethyldimethylol hydantoin, methylchloroisothiazolinone/methylisothiazolinone, benzoic acid, benzoyl peroxide, salicylamides, picric acid, xylenol, pyrocatechol, pyrogallol, phloroglucin, imidazolidinyl urea, diazolidinyl urea, benzyl alcohol, 2-bromo-2-nitropropane-1,3-diol, formalin, iodopropenyl butylcarbamate, chloroacetamide, methanamine, methyldibromonitrile glutaronitrile, glutaraldehyde, 5-bromo-5-nitro-1,3-dioxane, phenethyl alcohol, o-phenylphenol/sodium o-phenylphenol, sodium hydroxymethylglycinate, polymethoxy bicyclic oxazolidine, dimethoxane, thimersal, dichlorobenzyl alcohol, captan, chlorphenenesin, hexachlorophene, tetrachlorophene, 3,3′-dibromo-5,5′-dichloro-2,2′-dihydroxydiphenylamine, dichlorophene, chlorbutanol, glyceryl laurate, halogenated diphenyl ethers, 2,4,4′-trichloro-2′-hydroxy-diphenyl ether, 2,2′-dihydroxy-5,5′-dibromo-diphenyl ether, phenolic compounds, phenol, 2-methyl phenol, 3-methyl phenol, 4-methyl phenol, 4-ethyl phenol, 2,4-dichlorophenol, p-nitrophenol, 2,4-dimethyl phenol, 2,5-dimethyl phenol, 3,4-dimethyl phenol, 2,6-dimethyl phenol, 4-n-propyl phenol, 4-n-butyl phenol, 4-n-amyl phenol, 4-tert-amyl phenol, 4-n-hexyl phenol, 4-n-heptyl phenol, mono- and poly-alkyl and aromatic halophenols, p-chlorophenol, methyl p-chlorophenol, ethyl p-chlorophenol, n-propyl p-chlorophenol, n-butyl p-chlorophenol, n-amyl p-chlorophenol, sec-amyl p-chlorophenol, n-hexyl p-chlorophenol, cyclohexyl p-chlorophenol, n-heptyl p-chlorophenol, n-octyl p-chlorophenol, o-chlorophenol, methyl o-chlorophenol, ethyl o-chlorophenol, n-propyl o-chlorophenol, n-butyl o-chlorophenol, n-amyl o-chlorophenol, tert-amyl o-chlorophenol, n-hexyl o-chlorophenol, n-heptyl o-chlorophenol, o-benzyl p-chlorophenol, o-benzyl-m-methyl p-chlorophenol, o-benzyl-m, m-dimethyl p-chlorophenol, o-phenylethyl p-chlorophenol, o-phenylethyl-m-methyl p-chlorophenol, 3-methyl p-chlorophenol, 3,5-dimethyl p-chlorophenol, 6-ethyl-3-methyl p-chlorophenol, 6-n-propyl-3-methyl p-chlorophenol, 6-iso-propyl-3-methyl p-chlorophenol, 2-ethyl-3,5-dimethyl p-chlorophenol, 6-sec-butyl-3-methyl p-chlorophenol, 2-iso-propyl-3,5-dimethyl p-chlorophenol, 6-diethylmethyl-3-methyl p-chlorophenol, 6-iso-propyl-2-ethyl-3-methyl p-chlorophenol, 2-sec-amyl-3,5-dimethyl p-chlorophenol, 2-diethylmethyl-3,5-dimethyl p-chlorophenol, 6-sec-octyl-3-methyl p-chlorophenol, o-benzylphenol, p-chloro-o-benzylphenol, cresols (o-, m-, p-), p-chloro-m-cresol, p-bromophenol, methyl p-bromophenol, ethyl p-bromophenol, n-propyl p-bromophenol, n-butyl p-bromophenol, n-amyl p-bromophenol, sec-amyl p-bromophenol, n-hexyl p-bromophenol, cyclohexyl p-bromophenol, o-bromophenol, tert-amyl o-bromophenol, n-hexyl o-bromophenol, n-propyl-m,m-dimethyl o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5,6-terabromo-2-methylphenol, 5-methyl-2-pentylphenol, 4-isopropyl-3-methylphenol, para-chloro-meta-xylenol, chlorothymol, phenoxyethanol, phenoxyisopropanol, 5-chloro-2-hydroxydiphenylmethane, resorcinol and its derivatives, resorcinol, methyl resorcinol, ethyl resorcinol, n-propyl resorcinol, n-butyl resorcinol, n-amyl resorcinol, n-hexyl resorcinol, n-heptyl resorcinol, n-octyl resorcinol, n-nonyl resorcinol, phenyl resorcinol, benzyl resorcinol, phenylethyl resorcinol, phenylpropyl resorcinol, p-chlorobenzyl resorcinol, 5-chloro 2,4-dihydroxydiphenyl methane, 4′-chloro 2,4-dihydroxydiphenyl methane, 5-bromo 2,4-dihydroxydiphenyl methane, 4′-bromo 2,4-dihydroxydiphenyl methane, bisphenolic compounds, 2,2′-methylene bis(4-chlorophenol), 2,2′-methylene bis(3,4,6trichlorophenol), 2,2′-methylene bis(4-chloro-6-bromophenol), bis(2-hydroxy-3,5-dichlorophenyl) sulphide, bis(2-hydroxy-5-chlorobenzyl)sulphide, benzoic esters parabens such as methylparaben, propylparaben, butylparaben, ethylparaben, isopropylparaben, isobutylparaben, benzylparaben, sodium methylparaben, sodium propylparaben, halogenated carbanilides, 3,4,4′-trichlorocarbanilides, 3-trifluoromethyl-4,4′-dichlorocarbanilide, and 3,3′,4-trichlorocarbanilide.

8. The process according to claim 1 wherein component (b) includes an anionic surfactant.

9. The process according to claim 1 wherein component (b) includes a non-ionic surfactant.

10. The process according to claim 1 claims 1 or 2 wherein component (b) includes a mixture of an anionic surfactant and a non-ionic surfactant.

11. The process according to claim 1 claims 1 or 2 wherein component (b) includes a pH modifier.

12. A two-compartment dispenser comprising:
a first compartment comprising an aqueous composition comprising hydrogen peroxide as compsition (a);
a second compartment comprising an aqueous composition necessarily comprising one or more cationic surfactants having germicidal properties, and optionally further comprising one or more essential oils, other antimicrobial/germicidal agents, anionic surfactants, non-ionic surfactants, and pH modifiers as composition (b); and
dispensing means adapted to dispense the contents (or part thereof) of the compartments on to a surface either sequentially or simultaneously to form a mixture thereof wherein the mixture has pH of greater than 7.00.

13. The dispenser according to claim 12 wherein the mixture thereby formed has a pH of greater than 7.00.

14. The dispenser according to claim 12 wherein the one or more cationic surfactants having germicidal properties are characterized by the formula: 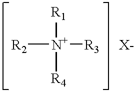
wherein at least one of R₁, R₂, R₃ and R₄ is a alkyl, aryl or alkylaryl substituent of from 6 to 26 carbon atoms, the remaining R₁, R₂, R₃ and R₄ are hydrocarbons usually containing no more than 12 carbon atoms, and X is any salt-forming anion.

15. The dispenser according to claim 12 wherein composition (b) includes one or more essential oils.

16. The dispenser according to claim 15 wherein (b) is selected from oils of anise, citrus, aniseed, roses, mint, camphor, lemon, orange, rosemary, wintergreen, thyme, lavender, cloves, hops, tea tree, citronella, wheat, barley, lemongrass, cedar leaf, cedarwood, cinnamon, fleagrass, geranium, sandalwood, violet, cranberry, eucalyptus, vervain, peppermint, gum benzoin, basil, fennel, fir, balsam, menthol, ocmea origanum, hydastis carradensis, berberidaceae daceae, ratanhiae, curcuma longa, anethol, catechole, camphene, pinocarvone, cedrol, thymol, eugenol, eucalyptol, ferulic acid, farnesol, hinokitiol, tropolone, limonene, menthol, methyl salicylate, carvacol, terpineol, verbenone, berberine, ratanhiae extract, caryophellene oxide, citronellic acid, curcumin, nerolidol and geraniol and mixtures thereof.

17. The dispenser according to claim 12 wherein composition (b) includes one or more antimicrobial/germicidal agents.

18. The dispenser according to claim 17 wherein the one or more antimicrobial/germicidal agents are selected from pyrithiones especially the zinc complex, dimethyldimethylol hydantoin, methylchloroisothiazolinone/methylisothiazolinone, benzoic acid, benzoyl peroxide, salicylamides, picric acid, xylenol, pyrocatechol, pyrogallol, phloroglucin, imidazolidinyl urea, diazolidinyl urea, benzyl alcohol, 2-bromo-2-nitropropane-1,3-diol, formalin, iodopropenyl butylcarbamate, chloroacetamide, methanamine, methyldibromonitrile glutaronitrile, glutaraldehyde, 5-bromo-5-nitro-1,3-dioxane, phenethyl alcohol, o-phenylphenol/sodium o-phenylphenol, sodium hydroxymethylglycinate, polymethoxy bicyclic oxazolidine, dimethoxane, thimersal, dichlorobenzyl alcohol, captan, chlorphenenesin, hexachlorophene, tetrachlorophene, 3,3′-dibromo-5,5′-dichloro-2,2′-dihydroxydiphenylamine, dichlorophene, chlorbutanol, glyceryl laurate, halogenated diphenyl ethers, 2,4,4′-trichloro-2′-hydroxy-diphenyl ether, 2,2′-dihydroxy-5,5′-dibromo-diphenyl ether, phenolic compounds, phenol, 2-methyl phenol, 3-methyl phenol, 4-methyl phenol, 4-ethyl phenol, 2,4-dichlorophenol, p-nitrophenol, 2,4-dimethyl phenol, 2,5-dimethyl phenol, 3,4-dimethyl phenol, 2,6-dimethyl phenol, 4-n-propyl phenol, 4-n-butyl phenol, 4-n-amyl phenol, 4-tert-amyl phenol, 4-n-hexyl phenol, 4-n-heptyl phenol, mono- and poly-alkyl and aromatic halophenols, p-chlorophenol, methyl p-chlorophenol, ethyl p-chlorophenol, n-propyl p-chlorophenol, n-butyl p-chlorophenol, n-amyl p-chlorophenol, sec-amyl p-chlorophenol, n-hexyl p-chlorophenol, cyclohexyl p-chlorophenol, n-heptyl p-chlorophenol, n-octyl p-chlorophenol, o-chlorophenol, methyl o-chlorophenol, ethyl o-chlorophenol, n-propyl o-chlorophenol, n-butyl o-chlorophenol, n-amyl o-chlorophenol, tert-amyl o-chlorophenol, n-hexyl o-chlorophenol, n-heptyl o-chlorophenol, o-benzyl p-chlorophenol, o-benzyl-m-methyl p-chlorophenol, o-benzyl-m, m-dimethyl p-chlorophenol, o-phenylethyl p-chlorophenol, o-phenylethyl-m-methyl p-chlorophenol, 3-methyl p-chlorophenol, 3,5-dimethyl p-chlorophenol, 6-ethyl-3-methyl p-chlorophenol, 6-n-propyl-3-methyl p-chlorophenol, 6-iso-propyl-3-methyl p-chlorophenol, 2-ethyl-3,5-dimethyl p-chlorophenol, 6-sec-butyl-3-methyl p-chlorophenol, 2-iso-propyl-3,5-dimethyl p-chlorophenol, 6-diethylmethyl-3-methyl p-chlorophenol, 6-iso-propyl-2-ethyl-3-methyl p-chlorophenol, 2-sec-amyl-3,5-dimethyl p-chlorophenol, 2diethylmethyl-3,5-dimethyl p-chlorophenol, 6-sec-octyl-3-methyl p-chlorophenol, o-benzylphenol, p-chloro-o-benzylphenol, cresols (o-, m-, p-), p-chloro-m-cresol, p-bromophenol, methyl p-bromophenol, ethyl p-bromophenol, n-propyl p-bromophenol, n-butyl p-bromophenol, n-amyl p-bromophenol, sec-amyl p-bromophenol, n-hexyl p-bromophenol, cyclohexyl p-bromophenol, o-bromophenol, tert-amyl o-bromophenol, n-hexyl o-bromophenol, n-propyl-m,m-dimethyl o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5,6-terabromo-2-methylphenol, 5-methyl-2-pentylphenol, 4-isopropyl-3-methylphenol, para-chloro-meta-xylenol, chlorothymol, phenoxyethanol, phenoxyisopropanol, 5-chloro-2-hydroxydiphenylmethane, resorcinol and its derivatives, resorcinol, methyl resorcinol, ethyl resorcinol, n-propyl resorcinol, n-butyl resorcinol, n-amyl resorcinol, n-hexyl resorcinol, n-heptyl resorcinol, n-octyl resorcinol, n-nonyl resorcinol, phenyl resorcinol, benzyl resorcinol, phenylethyl resorcinol, phenylpropyl resorcinol, p-chlorobenzyl resorcinol, 5-chloro 2,4-dihydroxydiphenyl methane, 4′-chloro 2,4-dihydroxydiphenyl methane, 5-bromo 2,4-dihydroxydiphenyl methane, 4′-bromo 2,4-dihydroxydiphenyl methane, bisphenolic compounds, 2,2′-methylene bis(4-chlorophenol), 2,2′-methylene bis(3,4,6-trichlorophenol), 2,2′-methylene bis(4-chloro-6-bromophenol), bis(2-hydroxy-3,5-dichlorophenyl) sulphide, bis(2-hydroxy-5-chlorobenzyl)sulphide, benzoic esters parabens such as methylparaben, propylparaben, butylparaben, ethylparaben, isopropylparaben, isobutylparaben, benzylparaben, sodium methylparaben, sodium propylparaben, halogenated carbanilides, 3,4,4′-trichlorocarbanilides, 3-trifluoromethyl-4,4′-dichlorocarbanilide, and 3,3′,4-trichlorocarbanilide.

19. The dispenser according to claim 12 wherein composition (b) includes one or more anionic surfactants.

20. The dispenser according to claim 12 wherein composition (b) includes one or more nonionic surfactants.

21. The dispenser according to claim 12 wherein composition (b) includes a mixture of an anionic surfactant and a non-ionic surfactant.

22. The dispenser according to claim 12 wherein composition (b) comprises a pH modifier.

23. A process for sanitizing and/or disinfecting and/or cleaning and/or stain removal at a surface according to claim 1, comprising applying to that surface a mixture of:
(a) an aqueous composition (a) comprising hydrogen peroxide; and
(b) an aqueous composition (b) comprising:
a cationic surfactant having germicidal properties,
one or more amine oxide surfactants;
one or more organic solvents;
a pH modifier;
and optionally one or more essential oils, other antimicrobial/germicidal agents,
other anionic surfactants, other non-ionic surfactants, and other pH modifiers, wherein compositions (a) and (b) are mixed not more than two hours before being applied to the surface requiring sanitizing and/or disinfecting and/or cleaning and/or stain removal, and the resulting solution has a pH of greater than 7.00.

24. A two-compartment dispenser comprising:
a first compartment containing (a) an aqueous composition comprising hydrogen peroxide; and
a second compartment containing (b) an aqueous composition comprising:
a cationic surfactant having germicidal properties,
one or more amine oxide surfactants;
one or more organic solvents;
a pH modifier;
and optionally one or more essential oils, other antimicrobial/germicidal agents,
other anionic surfactants, other non-ionic surfactants, and other pH modifiers,
dispensing means adapted to dispense the contents (or part thereof) of the first compartment and the second compartment onto a surface either sequentially or simultaneously to form a mixture thereof, wherein the resulting mixture has a pH of greater than 7.00.
